(19) United States
(12) Patent Application Publication
(10) Pub. No.: US 2026/0277002 A1
(43) Pub. Date: Sep. 17, 2026

(54) LIGHT GUIDE BODY

(71) Applicant: HONDA MOTOR CO.,LTD., Tokyo (JP)

(72) Inventor: Takeomi OKIMITSU, Saitama (JP)

(21) Appl. No.: 19/678,191

(22) Filed: May 15, 2026

Related U.S. Application Data
(63) Continuation of application No. PCT/JP2024/041779, filed on Nov. 26, 2024.

(30) Foreign Application Priority Data
Dec. 28, 2023 (JP) 2023-223170

(51) Int. Cl. G02B 27/01; F21V 8/00

(52) U.S. Cl. CPC G02B 27/0172; G02B 6/0065; G02B 2027/0178

(57) ABSTRACT

A light guide body 100 includes a light input portion 110 provided such that light S is input in a Z-axis direction and having a light input position 111a, a light guide portion 120 configured to guide the light input to the light input portion in a Y-axis direction, and a light output portion 130 provided such that the light guided by the light guide portion is output in the Z-axis direction and having a light output position 131a.

### BACKGROUND

### 1. TECHNICAL FIELD

The present invention relates to a light guide body.

### 2. RELATED ART

In recent years, in the fields of virtual reality (VR) technology and augmented reality (AR) technology, research and development of a head-mounted display (HMD) that is mounted on the head of a user and displays parallax images corresponding to the left and right eyes as virtual images to project a stereoscopic image, and a head-up display (HUD) that projects a distant virtual image on a windshield in superimposition with the reality in front of a driver have progressed (see, for example, Patent Document 1). In these technologies, it is required to efficiently guide light including image information such as a parallax image and a distant virtual image from a light emitting source to a user’s eye or a display unit such as a windshield.

Patent Document 1: Japanese patent application publication 2020-118963

### BRIEF DESCRIPTION OF DRAWINGS

FIG. 1A illustrates an overall configuration of a light guide body according to the present embodiment;

FIG. 1B illustrates detailed configurations of a light input portion and a boundary portion;

FIG. 1C illustrates an overall configuration of the light input portion, a light guide portion, a light output portion, and the boundary portion;

FIG. 2A illustrates a schematic configuration of a mounted device and light guide of light in the light guide body;

FIG. 2B illustrates a mounted state of the mounted device and light guide of light through the light guide body;

FIG. 3 illustrates a schematic configuration of a display device and light guide of light in the light guide body;

FIG. 4 illustrates a flow of a first manufacturing method of the light guide body;

FIG. 5A illustrates a mold and a state of the inside of the mold after an insert setting step in the first manufacturing method in a front view (a cross section related to a reference line AA in FIG. 5B);

FIG. 5B illustrates the mold and a state of the inside of the mold after the insert setting step in the first manufacturing method in a side view (a cross section related to a reference line BB in FIG. 5A);

FIG. 5C illustrates a flow of a resin in a molding step in the first manufacturing method;

FIG. 5D illustrates a state in which inserts are extracted in an insert extraction step in the first manufacturing method;

FIG. 6 illustrates a flow of a second manufacturing method of the light guide body;

FIG. 7A illustrates a state of the inside of a mold after a first mold setting step in the second manufacturing method in a front view;

FIG. 7B illustrates configurations of a first light input portion, a first light guide portion, and a first light output portion molded through a light input portion molding step using a first mold in the second manufacturing method;

FIG. 7C illustrates bottom surfaces of the first light input portion, the first light guide portion, and the first light output portion and a configuration of a continuous portion;

FIG. 7D illustrates a second mold and a state of the inside of the mold after an insert setting step in the second manufacturing method in a front view;

FIG. 7E illustrates a second mold and a state of the inside of the mold after an insert setting step in the second manufacturing method in a perspective view;

FIG. 8 illustrates a flow of a third manufacturing method of the light guide body;

FIG. 9A illustrates configurations of a first light input portion, a first light guide portion, and a first light output portion molded through a light input portion molding step in the third manufacturing method;

FIG. 9B illustrates configurations of a second light input portion, a second light guide portion, and a second light output portion molded through a light guide portion molding step in the third manufacturing method; and

FIG. 9C illustrates a state in which the first light input portion, the first light guide portion, and the first light output portion and the second light input portion, the second light guide portion, and the second light output portion are welded through a welding step in the third manufacturing method.

### DESCRIPTION OF EXEMPLARY EMBODIMENTS

Hereinafter, the present invention will be described through embodiments of the invention, but the following embodiments do not limit the invention according to the claims. In addition, all combinations of features described in the embodiments are not necessarily essential to solution of the present invention.

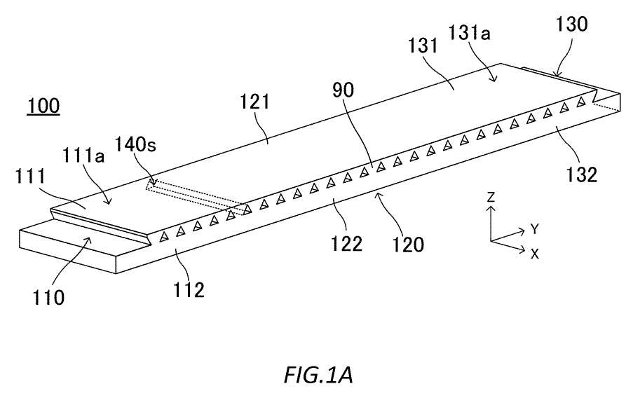

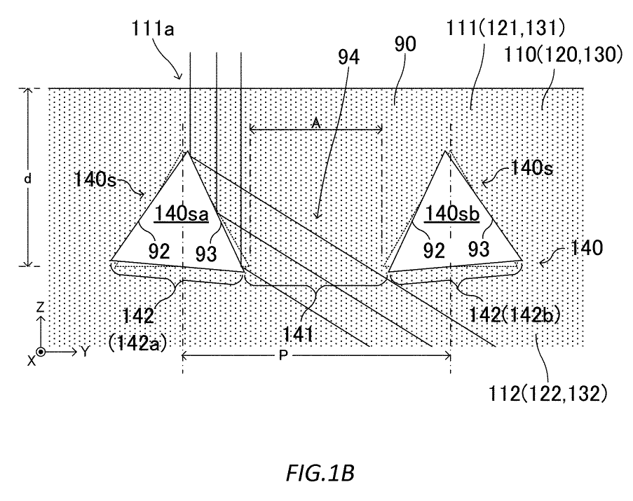

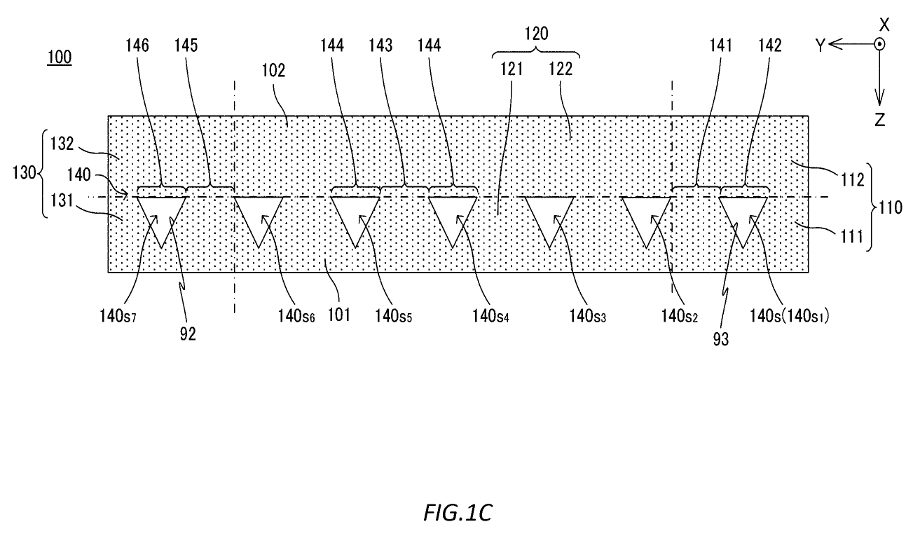

FIGS. 1A, 1B, and 1C illustrate an overall configuration of a light guide body 100, detailed configurations of a light input portion 110 and a boundary portion 140, and an overall configuration of the light input portion 110, a light guide portion 120, a light output portion 130, and the boundary portion 140 according to the present embodiment, respectively. The light guide body 100 is an optical device that guides and outputs the light input from a light input position 111a of the light input portion 110 to a light output position 131a different from the light input position 111a without leakage or with little leakage, and includes the light input portion 110, the light guide portion 120, the light output portion 130, and the boundary portion 140. As a whole, the light guide body 100 has a substantially plate shape extending in a two-dimensional direction with a short side in an X-axis direction and a long side in a Y-axis direction, and having a thickness in a Z-axis direction. In FIG. 1C and other drawings, -Y and +Z side step portions of the light input portion 110 and +Y and +Z side step portions of the light output portion 130 are not illustrated.

The light input portion 110 is an optical member that has the light input position 111a provided such that light is input in the Z-axis direction and collects light input from the light input position 111a in the -Z direction, and has a first light input portion 111 and a second light input portion 112 adjacent to each other in the Z-axis direction, and a continuous portion 141 and a discontinuous portion 142 provided at a boundary between the first light input portion 111 and the second light input portion 112. In the present embodiment, the first light input portion 111 and the second light input portion 112 are integrally stacked in the Z-axis direction.

The first light input portion 111 is an upper portion of the light input portion 110 provided with the light input position 111a. The first light input portion 111 includes one or a plurality of (one in the present embodiment) light collecting elements 90. Each of the light collecting elements 90 is a columnar member with an inverted substantially isosceles trapezoidal cross section having a maximum width P in the Y-axis direction and a height d in the Z-axis direction and extending in the X-axis direction, wherein the light collecting elements 90 are arranged in parallel in the Y-axis direction with +Z sides of Y side surfaces (that is, a +Y side surface and a -Y side surface) being in contact with each other and -Z sides being separated from each other. In the present embodiment, a plurality of light collecting elements 90 are connected to each other and integrally molded (however, for convenience of explaining the configuration and function of the light input portion 110, the first light input portion 111 will be described as including the plurality of light collecting elements 90). As a result, the first light input portion 111 extends in the Y-axis direction, the +Z surfaces of the plurality of light collecting elements 90 are connected to each other to form a planar light input surface having a width in the X-axis direction, and the light input position 111a at which light is input in the -Z direction is provided on the light input surface.

In addition, two adjacent light collecting elements 90 form between them a hollow space (simply referred to as a space) 140s having a triangular cross section and extending in the X-axis direction.

Note that the plurality of light collecting elements 90 may be arranged in parallel to be separated from each other in the Y-axis direction. In such a case, the light input position 111a is provided on the +Z surface of one or some of the plurality of light collecting elements 90.

The light collecting element 90 has reflecting surfaces 92 and 93 and a light transmitting portion 94 located below (in the -Z direction) the light input position 111a. Here, the light collecting element 90 can be formed using, for example, a resin having a high refractive index such as an acrylic resin (refractive index 1.49) or a polycarbonate resin (refractive index 1.58), or glass (for example, refractive index 1.51 to 1.53 with respect to BK7). The boundaries between the light collecting element 90 and the spaces 140s, that is, the ±Y side surfaces of the light collecting element 90 function as the reflecting surfaces 92 and 93 that reflect some of the light, which is input into the light collecting element 90 in the Z-axis direction at the light input position 111a, in the ±Y and -Z directions.

When the light enters the ±Y side surfaces from the inside of the light collecting element 90 at an angle equal to or larger than a critical angle, the light is totally reflected. The critical angle is about 42 degrees for the acrylic resin, about 41 degrees for the polycarbonate resin, and about 42 degrees for the glass. Therefore, the ±Y side surfaces of the light collecting element 90 are formed such that the normal line thereof forms an angle equal to or larger than a critical angle with respect to a light input direction (the Z-axis direction in the present embodiment). On the other hand, a portion of the light collecting element 90 between the reflecting surfaces 92 and 93 functions as the light transmitting portion 94 through which some of the light input from the light input position 111a (the remainder that does not enter the reflecting surfaces 92 and 93 in the present example) and the reflected light reflected by the reflecting surfaces 92 and 93 pass.

The reflecting surfaces 92 and 93 are disposed on the +Y side and the -Y side of the light transmitting portion 94 so as to face each other, and are provided so as to reflect the light input from the light input position 111a toward the light transmitting portion 94. Here, the reflecting surfaces 92 and 93 are linearly formed on a YZ cross section. In addition, in order to increase the reflectance, the reflecting surfaces 92 and 93, that is, the ±Y side surfaces of the light collecting element 90 may be mirror-finished. In addition, a reflecting film may be provided using metal or the like.

The second light input portion 112 is a lower portion of the light input portion 110, and is a portion that guides the light reflected by the reflecting surfaces 92 and 93 of the first light input portion 112 to the light guide portion 120. The second light input portion 112 is formed in a plate shape extending in the X and Y directions and having a thickness in the Z-axis direction using the same material as the first light input portion 111.

The continuous portion 141 is provided so that the light transmitting portion 94 of the first light input portion 111 and the second light input portion 112 are physically continuous to guide the light input from the light input position 111a, that is, the reflected light reflected by the reflecting surfaces 92 and 93 (and remaining light that has not entered the reflecting surfaces 92 and 93) to the second light input portion 112. The continuous portion 141 has an opening width A in the Y-axis direction and extends in the X-axis direction. The continuous portion 141 can be formed of the same material as the light collecting element 90. Further, the continuous portion 141 may be integrally formed with the first light input portion 111 and/or the second light input portion 112 as a part thereof.

The discontinuous portion 142 is provided such that the reflecting surfaces 92 and 93 of the first light input portion 111 and the second light input portion 112 are separated from each other, and is disposed adjacent to each of the ±Y sides of the continuous portion 141. Since the discontinuous portion 142 separates the second light input portion 112 from the first light input portion 111 (the reflecting surfaces 92 and 93 formed on the ±Y side surfaces) and forms the space 140s (for example, 140s₁) therebetween, an interface between the discontinuous portion 142 and the second light input portion 112 functions as a reflecting surface that reflects the reflected light input from the light transmitting portion 94 of the first light input portion 111 to the second light input portion 112 via the continuous portion 141 and guides the reflected light to the light guide portion 120. In order to increase the reflectance, the interface between the discontinuous portion 142 and the second light input portion 112, that is, the +Z end surface of the second light input portion 112 below the space 140s may be mirror-finished. In addition, a reflecting film may be provided using metal or the like.

The light guide portion 120 is an optical member that guides the light input to the light input portion 110 in a direction (in the present embodiment, the Y-axis direction) intersecting (or orthogonal or substantially orthogonal to) the Z-axis direction, and has a first light guide portion 121 and a second light guide portion 122 adjacent to each other in the Z-axis direction, and a continuous portion 143 and a discontinuous portion 144 provided at a boundary between the first light guide portion 121 and the second light guide portion 122. In the present embodiment, the first light guide portion 121 and the second light guide portion 122 are integrally stacked in the Z-axis direction.

The first light guide portion 121 is an upper portion of the light guide portion 120, and is formed by arranging and integrally connecting a plurality of light collecting elements 90 in the Y-axis direction similarly to the first light input portion 111. As a result, the first light guide portion 121 extends in the Y-axis direction, and forms a space 140s (for example, 140s₂ to 140s₆) having a triangular cross section and extending in the X-axis direction between two adjacent light collecting elements 90. Note that the configurations of the light collecting element 90 and the reflecting surfaces 92 and 93 are similar to those in the light input portion 110 described above.

The second light guide portion 122 is a lower portion of the light guide portion 120, and is a portion that guides the light, which enters from the light input position 111a of the light input portion 110, is reflected by the reflecting surfaces 92 and 93 of the light input portion 110, and is received through the second light input portion 112, to the light output portion 130. The second light guide portion 122 is formed in a plate shape extending in the X and Y directions and having a thickness in the Z-axis direction using the same material as the first light guide portion 121.

Similarly to the continuous portion 141, the continuous portion 143 is provided such that the light transmitting portion 94 of the first light guide portion 121 and the second light guide portion 122 are physically continuous.

Similarly to the discontinuous portion 142, the discontinuous portion 144 is provided such that the first light guide portion 121 (the reflecting surfaces 92 and 93) and the second light guide portion 122 are separated from each other, and is disposed adjacent to each of the ±Y sides of the continuous portion 143. Since the discontinuous portion 144 separates the second light guide portion 122 from the first light guide portion 121 (the reflecting surfaces 92 and 93 formed on the ±Y side surfaces) and forms the space 140s (140s₂ to 140s₆) therebetween, an interface between the discontinuous portion 144 and the second light guide portion 122 functions as a reflecting surface that reflects the light entering from the light input portion 120 (the second light input portion 112) and guides the reflected light to the light output portion 130. In order to increase the reflectance, the interface between the discontinuous portion 144 and the second light guide portion 122, that is, the +Z end surface of the second light guide portion 122 below the space 140s may be mirror-finished. In addition, a reflecting film may be provided using metal or the like.

The light output portion 130 is an optical member that has the light output position 131a provided so that the light guided by the light guide portion 120 is output in a direction (in the present embodiment, the Z-axis direction) intersecting (or orthogonal or substantially orthogonal to) the Y-axis direction, and outputs light in the +Z direction from the light output position 131a, and has a first light output portion 131 and a second light output portion 132 adjacent to each other in the Z-axis direction, and a continuous portion 145 and a discontinuous portion 146 provided at a boundary between the first light output portion 131 and the second light output portion 132. In the present embodiment, the first light output portion 131 and the second light output portion 132 are integrally stacked in the Z-axis direction.

The first light output portion 131 is an upper portion of the light output portion 130, and is formed by arranging and integrally connecting one or a plurality of (one in the present embodiment) light collecting elements 90 in the Y-axis direction similarly to the first light input portion 111. As a result, the first light output portion 131 extends in the Y-axis direction, the +Z surface thereof expands in the X and Y directions to form a planar light output surface, and the light output position 131a at which light is output in the +Z direction is provided on the light output surface. The light collecting element 90 has reflecting surfaces 92 and 93 and a light transmitting portion 94 located below (in the -Z direction) the light output position 131a. Furthermore, a space 140s having a triangular cross section and extending in the X-axis direction is formed between two adjacent light collecting elements 90. Note that the configurations of the light collecting element 90 and the reflecting surfaces 92 and 93 are similar to those in the light input portion 110 described above. These reflecting surfaces 92 and 93 reflect the light guided in the Y-axis direction by the light guide portion 120 in the Z-axis direction.

The second light output portion 132 is a lower portion of the light output portion 130, and is a portion that sends the light guided through the light guide portion 120 (second light guide portion 122) to the first light output portion 131. The second light output portion 132 is formed in a plate shape extending in the X and Y directions and having a thickness in the Z-axis direction using the same material as the first light output portion 131. The light sent to the first light output portion 131 by the second light output portion 132 is reflected by the reflecting surfaces 92 and 93 of the first light output portion 131 and is output in the Z-axis direction from the light output position 131a of the light output portion 130.

Similarly to the continuous portion 141, the continuous portion 145 is provided such that the light transmitting portion 94 of the first light output portion 131 and the second light output portion 132 are physically continuous.

Similarly to the discontinuous portion 142, the discontinuous portion 146 is provided such that the first light output portion 131 (the reflecting surfaces 92 and 93) and the second light output portion 132 are separated from each other, and is disposed adjacent to each of the ±Y sides of the continuous portion 145. Since the discontinuous portion 146 separates the second light output portion 132 from the first light output portion 131 (the reflecting surfaces 92 and 93 formed on the ±Y side surfaces) and forms the space 140s (for example, 140s₇) therebetween, an interface between the discontinuous portion 146 and the second light output portion 132 functions as a reflecting surface that reflects the light sent to the light transmitting portion 94 of the first light output portion 131 via the continuous portion 145 from the second light guide portion 122 and guides the reflected light to the first light output portion 131. In order to increase the reflectance, the interface between the discontinuous portion 146 and the second light output portion 132, that is, the +Z end surface of the second light output portion 132 below the space 140s may be mirror-finished. In addition, a reflecting film may be provided using metal or the like.

The boundary portion 140 is a portion located at the boundary between the first light input portion 111, the first light guide portion 121, and the first light output portion 131 and the second light input portion 112, the second light guide portion 122, and the second light output portion 132, and includes the continuous portions 141, 143, and 145 and the discontinuous portions 142, 144, and 146 described above.

Note that, in the light guide body 100 according to the present embodiment, the first light input portion 111, the first light guide portion 121, and the first light output portion 131 are arranged in the Y-axis direction and integrally molded. These integrally molded portions are also referred to as an upper portion 101. In addition, the second light input portion 112, the second light guide portion 122, and the second light output portion 132 are arranged in the Y-axis direction and integrally molded. These integrally molded portions are also referred to as a lower portion 102. That is, the light input portion 110, the light guide portion 120, and the light output portion 130 are arranged in the Y-axis direction and integrally molded.

In the present embodiment, a plurality of reflecting surfaces 92 and 93 and a plurality of light transmitting portions 94 of the light input portion 110, the light guide portion 120, and the light output portion 130 are arranged in the Y-axis direction in the upper portion 101 of the light guide body 100 by integrally forming the light collecting elements 90 in parallel in the Y-axis direction. Accordingly, one or a plurality of continuous portions 141, 143, and 145 and one or a plurality of discontinuous portions 142, 144, and 146 are provided at each of the boundaries between the first light input portion 111, the first light guide portion 121, and the first light output portion 131 and the second light input portion 112, the second light guide portion 122, and the second light output portion 132, and the plurality of continuous portions 141, 143, and 145 and the plurality of discontinuous portions 142, 144, and 146 are alternately disposed in the Y-axis direction. Here, each of the continuous portions 141, 143, and 145 has a width A (equal to the width of the light transmitting portion 94) in the Y-axis direction, and is periodically arranged at a pitch P in the Y-axis direction. In the present embodiment, each of the discontinuous portions 142, 144, and 146 has a width substantially equal to that of each of the continuous portions 141, 143, and 145, and is disposed between the continuous portions 141, 143, and 145. As a result, an aperture ratio A/P is about 1/2. The continuous portions 141, 143, and 145 and the discontinuous portions 142, 144, and 146 adjacent thereto may have different widths in the Y-axis direction, and the aperture ratio A/P may be larger or smaller than about 1/2.

As illustrated in FIG. 1B, the reflecting surfaces 92 and 93 of the light input portion 110 reflect the light input from the light input position 111a toward the second light input portion 112. In particular, the reflecting surfaces 92 and 93 reflect light, which is input in a direction (the Z-axis direction in the present embodiment) intersecting (or orthogonal or substantially orthogonal to) the light input surface (the +Z surface of the first light input portion 111) to which the light input position 111a belongs, toward the second light input portion 112. Here, the light reflected by the reflecting surface 93 forms parallel light and passes through the continuous portion 141, that is, the light reflected on the +Z side of the reflecting surface 93 passes through the +Y side of the continuous portion 141, the light reflected at the center of the reflecting surface 93 passes through the center of the continuous portion 141, and the light reflected on the -Z side of the reflecting surface 93 passes through the -Y side of the continuous portion 141 and enters the second light input portion 112. Note that the light reflected by the reflecting surface 92 forms parallel light in the same manner as the light reflected by the reflecting surface 93 except that the direction in which the light is directed is reversed, and enters the second light input portion 112.

Note that the reflecting surfaces 92 and 93 of the light output portion 130 reflect the light sent via the light guide portion 120 and the second light output portion 132, and output the light from the light output position 131a of the light output portion 130. In particular, the reflecting surfaces 92 and 93 reflect the light sent via the light guide portion 120 and the second light output portion 132, and output the light in a direction (the Z-axis direction in the present embodiment) intersecting (or orthogonal or substantially orthogonal to) the light output surface (the +Z surface of the first light output portion 131) to which the light output position 131a belongs. Here, the light sent from the second light output portion 132 forms parallel light, passes through the continuous portion 145, enters the reflecting surface 92, is reflected, and is output from the light output position 131a in the +Z direction. Note that the light reflected by the reflecting surface 93 forms parallel light and is output from the light output position 131a, in the same manner as the light reflected by the reflecting surface 92 except that the direction in which the light enters is reversed.

Note that the discontinuous portion 142 is disposed below the reflecting surfaces 92 and 93 of the light input portion 110 to include a discontinuous portion 142b that separates the reflecting surface 92 from the second light input portion 112 and a discontinuous portion 142a that separates the reflecting surface 93 from the second light input portion 112. In addition, by arranging the plurality of light collecting elements 90 in parallel in the Y-axis direction in the light input portion 110, the space 140s having a triangular cross section as viewed in the X-axis direction is formed by the Y side surfaces of the two adjacent light collecting elements 90 and the discontinuous portion 142 (the +Z end portion of the second light input portion 112) on their inner sides, and the reflecting surfaces 92 and 93 of the two adjacent light collecting elements 90 have opposite orientations to each other across the space 140s, and the discontinuous portions 142 positioned below them are continuous to each other.

Further, an end portion of the discontinuous portion 142 on a side of the second light input portion 112 (that is, the interface between the second light input portion 112 and the discontinuous portion 142) may be inclined with respect to the Y-axis direction. Here, the interfaces between the second light input portion 112 and each of the adjacent discontinuous portions 142 may be inclined in different directions with respect to the Y-axis direction. The interface between the second light input portion 112 and the discontinuous portion 142a may be inclined in a clockwise direction with respect to the Y axis, and the interface between the second light input portion 112 and the discontinuous portion 142b may be inclined in a counterclockwise direction with respect to the Y axis. The discontinuous portions 142 arranged in the Y-axis direction may include the discontinuous portions 142a and the discontinuous portions 142b alternately arranged.

Furthermore, the reflecting surfaces 92 and 93 included in one light collecting element 90 and facing each other have opposite orientations and equal inclination angles with respect to the Z axis. Here, the inclination angles may be different from each other or alternately different for the adjacent light collecting elements 90. The reflecting surfaces 92 and 93 having opposite orientations to each other across the space 140s between the two adjacent light collecting elements 90 have different inclination angles. The triangular cross sections of the plurality of spaces 140s arranged in the Y-axis direction may be rotated in alternately different directions. Here, the rotation of the plurality of spaces 140s is rotation around a reference axis parallel to the X-axis direction passing through the center of the space 140s on the YZ plane. In the present example, a left space 140sa is rotated clockwise and a right space 140sb is rotated counterclockwise with respect to a state before rotation indicated by a dotted line in the drawing (that is, a state in which a base of a triangle is parallel to the Y-axis direction). As a result, the space 140sa rotated clockwise and the space 140sb rotated counterclockwise are alternately arranged in the Y-axis direction.

When the plurality of spaces 140s are not rotated, the boundary portion 140 forms a straight line extending in the Y-axis direction in the YZ plane, and the continuous portion 141 and the discontinuous portion 142 are also linearly continuous in the YZ plane. When the plurality of spaces 140s are rotated, the boundary portion 140 forms a non-straight line that is repeatedly bent in the ±Z directions and extends in the Y-axis direction in the YZ plane, and the continuous portion 141 and the discontinuous portion 142 are also non-linearly continuous in the YZ plane.

The same applies to the reflecting surfaces 92 and 93 and the spaces 140s of the light guide portion 120 and the light output portion 130, the continuous portion 143 and the discontinuous portion 144 between the first light guide portion 121 and the second light guide portion 122, and the continuous portion 145 and the discontinuous portion 146 between the first light output portion 131 and the second light output portion 132.

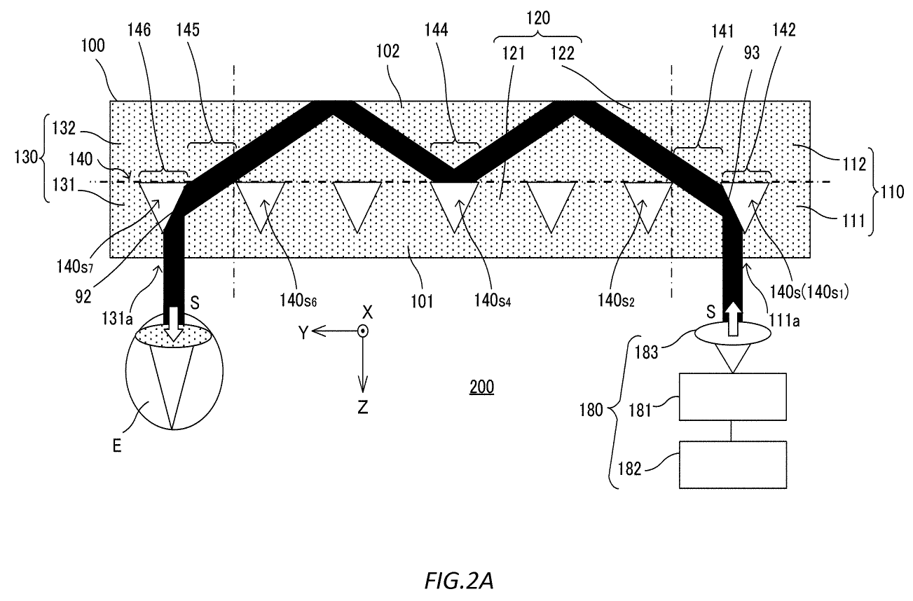

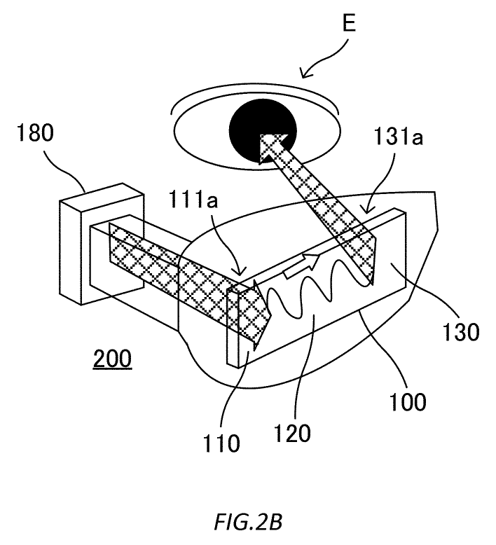

FIG. 2A illustrates a schematic configuration of a mounted device 200 according to the present embodiment and light guide of light S in the light guide body 100. The mounted device 200 is, for example, a head mounted display (HMD) that is mounted on the head of a user, and includes the light guide body 100 and a light emitting source 180. The light guide body 100 is configured as described above.

The light emitting source 180 is a device that emits light, and includes a light source 181, a storage unit 182, and an optical system 183. The light source 181 is a device that generates light. The light includes information of at least one of a video and an image. The storage unit 182 is a storage device that stores information. The optical system 183 includes an optical element such as a lens element that sends the light generated by the light source 181 in the +Z direction toward the light input position 111a of the light guide body 100.

FIG. 2B illustrates a mounted state of the mounted device 200 and light guide of light through the light guide body 100. When the user mounts the mounted device 200 on the head (not illustrated), the light output position 131a of the light guide body 100 is positioned in front of the eye, and the light emitting source 180 is disposed beside the head. When the mounted device 200 is operated, the light emitting source 180 reads the recorded information from the storage unit 182, activates the light source 181 according to the information to generate light including information of at least one of a video and an image, and inputs the light to the light input position 111a of the light guide body 100 through the optical system 183 in the -Z direction.

As illustrated in FIG. 2A, the light S output from the light emitting source 180 and entering in the -Z direction from the light input position 111a enters the reflecting surface 93 of the light input portion 110. The light S is reflected by the reflecting surface 93 toward the light transmitting portion 94, enters the second light input portion 112 via the continuous portion 141, and is guided to the light guide portion 120 in the +Y direction. In the light guide portion 120, the light S is reflected by the -Z surface of the second light guide portion 122 to be directed in the +Z direction, is reflected by the boundary between the second light guide portion 122 and the discontinuous portion 144 located on the -Z side of the space 140s₄ to be directed in the -Z direction, is reflected again by the -Z surface of the second light guide portion 122 to be directed in the +Z direction, and is guided to the second light output portion 132. In this manner, the light S is guided in the +Y direction (an arrow direction in FIG. 2B) in the light guide portion 120. In the light output portion 130, the light S is guided from the second light output portion 132 to the first light output portion 131 via the continuous portion 145, is reflected by the reflecting surface 92 toward the light output surface (the +Z surface of the first light output portion 131), and is output from the light output position 131a in antiparallel (in opposite direction) to the input direction of the light S at the light input position 111a, that is, in the +Z direction. The light S output from the light output position 131a enters the eye E of the user. As a result, the user can view a video or an image represented by light.

The inclination angle of the discontinuous portion 144 and/or the inclination angle of the reflecting surfaces 92 and 93 are determined such that the light S entering the second light guide portion 122 does not leak to the first light guide portion 121 through the continuous portion 143. In addition, the light S is not limited to being input to the light input position 111a in the -Z direction but may be input at an angle with respect to the Z-axis direction, and is not limited to being output from the light output position 131a in the +Z direction but may be output at an angle with respect to the Z-axis direction. In such a case, the output direction of the light S at the light output position 131a is opposite to the input direction of the light S at the light input position 111a with respect to the Z-axis direction.

Note that the mounted device 200 according to the present embodiment is a monocular mounted device, but may be a binocular mounted device including two mounted devices 200.

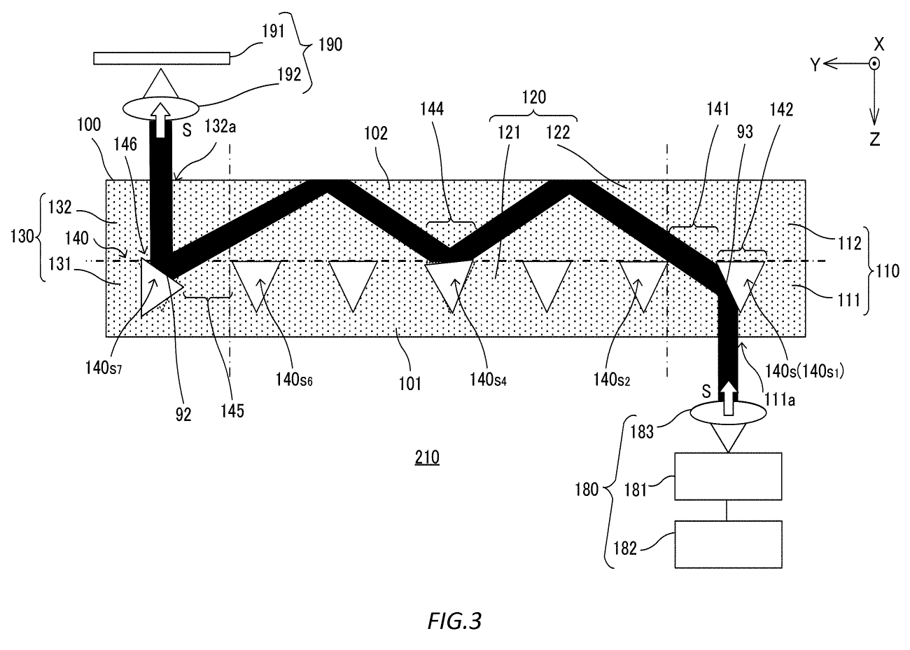

FIG. 3 illustrates a schematic configuration of a display device 210 and light guide of the light S in the light guide body 100. The display device 210 is, for example, a head-up display (HUD) mounted in front of a driver’s seat of a passenger car, and includes the light guide body 100, the light emitting source 180, and a display unit 190.

The light guide body 100 is configured as described above. However, the space 140s₄ between a first light guide body 121 and a second light guide body 122 is rotated counterclockwise to some degree. As a result, the light reflected at the interface between the second light guide body 122 and the space 140s₄ is guided in the second light guide portion 122 at a smaller angle with respect to the Y-axis direction. In addition, the space 140s₇ between the first light output portion 131 and the second light output portion 132 is rotated counterclockwise by about 90 degrees. As a result, the light output position 132a is provided on the -Z surface of the second light output portion 132, and the light S entering the first light output portion 131 from the second light output portion 132 via the continuous portion 145 is reflected by the reflecting surface 92 to be directed in the -Z direction, and is output in the -Z direction from the light output position 132a toward the display unit 190 via the second light output portion 132.

The light emitting source 180 is configured similarly to that in the mounted device 200 described above.

The display unit 190 is a display device that displays information of at least one of a video and an image, such as a windshield of an automobile, and includes a display surface 191 and an optical system 192. The display surface 191 is one surface such as a windshield on which the light S is projected. The optical system 192 includes an optical element such as a lens element that sends the light output from the light guide body 100 toward the display surface 191 in the -Z direction.

In the display device 210, the light S output from the light emitting source 180 and entering in the -Z direction from the light input position 111a enters the reflecting surface 93 of the light input portion 110. The light S is reflected by the reflecting surface 93 toward the light transmitting portion 94, enters the second light input portion 112 via the continuous portion 141, and is guided to the light guide portion 120 in the +Y direction. In the light guide portion 120, the light S is reflected by the -Z surface of the second light guide portion 122 to be directed in the +Z direction, is reflected by the boundary between the second light guide portion 122 and the discontinuous portion 144 located on the -Z side of the space 140s₄ to be directed in the -Z direction, is reflected again by the -Z surface of the second light guide portion 122 to be directed in the +Z direction, and is guided to the second light output portion 132. In this manner, the light S is guided in the +Y direction in the light guide portion 120. In the light output portion 130, the light S is guided from the second light output portion 132 to the first light output portion 131 via the continuous portion 145, is reflected by the reflecting surface 92 to be directed in the -Z direction, is reflected by the reflecting surface 92 toward the light output surface (in the case of the present example, the -Z surface of the second light output portion 132), and is output from the light output position 132a via the second light output portion 132 in parallel (in the same direction) to the input direction of the light S at the light input position 111a, that is, in the -Z direction. The light S output from the light output position 131a is projected on the display surface 191 via the optical system 192 of the display unit 190. As a result, the user can view a video or an image projected on the display surface 191.

The inclination angle of the discontinuous portion 144 and/or the inclination angle of the reflecting surfaces 92 and 93 are determined such that the light S entering the second light guide portion 122 does not leak to the first light guide portion 121 through the continuous portion 143. In addition, the light S is not limited to being input to the light input position 111a in the -Z direction but may be input at an angle with respect to the Z-axis direction, and is not limited to being output from the light output position 132a in the -Z direction but may be output at an angle with respect to the Z-axis direction. In such a case, the output direction of the light S at the light output position 132a is opposite to the input direction of the light S at the light input position 111a with respect to the Z-axis direction.

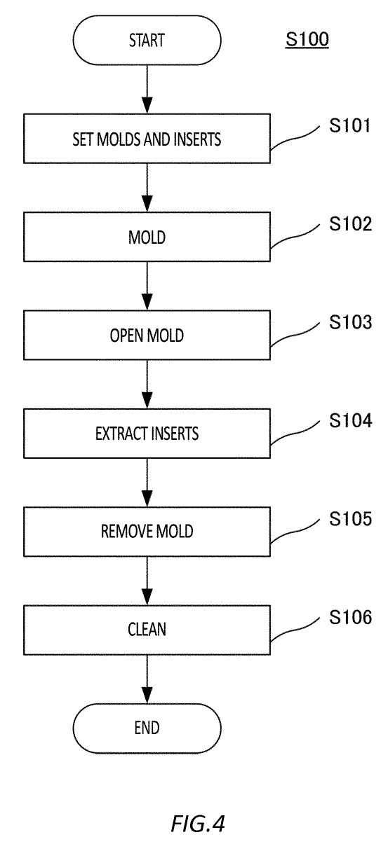

FIG. 4 illustrates a flow S100 of a first manufacturing method of the light guide body 100. In the present embodiment, as an example, an acrylic resin is used as a molding material of the light guide body 100. That is, the light input portion 110, the light guide portion 120, and the light output portion 130 are formed of the same material.

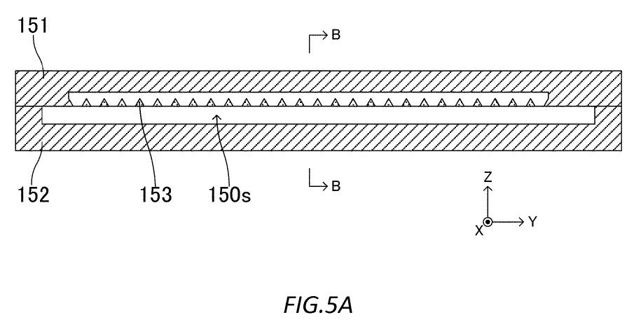

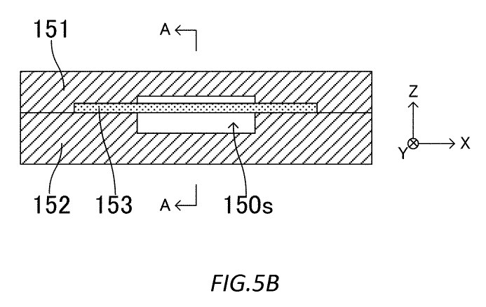

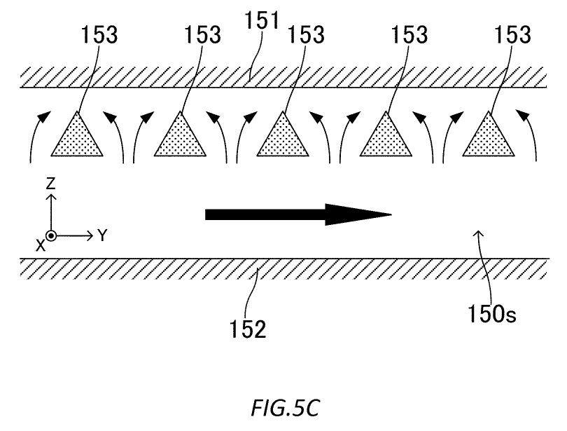

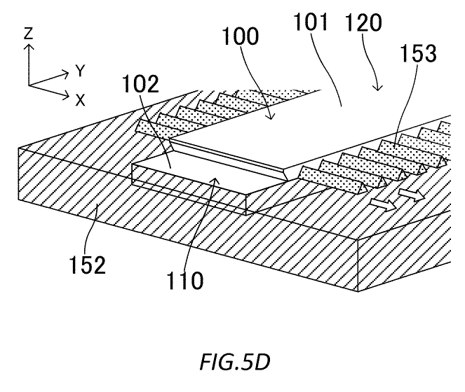

In step S101, molds 151 and 152 and a plurality of inserts 153 are set. FIGS. 5A and 5B show a state of the inside of the molds 151 and 152 in a front view (with respect to a reference line AA in FIG. 5B) and a side view (with respect to a reference line BB in FIG. 5A), respectively. The mold 151 is a metal mold for forming the first light input portion 111, the first light guide portion 121, and the first light output portion 131 (that is, the upper portion 101 of the light guide body 100), and includes an internal space having a size and a shape capable of accommodating the upper portion 101 and the plurality of inserts 153. The mold 152 is a metal mold for forming the second light input portion 112, the second light guide portion 122, and the second light output portion 132 (that is, the lower portion 102 of the light guide body 100), and includes an internal space having a size and a shape capable of accommodating the lower portion 102. The plurality of inserts 153 are metal molds for forming the space 140s in the upper portion 101 (between the plurality of light collecting elements 90), and are solid columnar bodies having a substantially isosceles triangular cross-sectional shape.

The mold 152 is disposed with its internal space oriented in the +Z direction, the plurality of inserts 153 are arranged on the mold 152 in the Y-axis direction to straddle the internal space of the mold 152 in the X-axis direction, and the mold 151 is placed on the mold 152 with its internal space oriented in the -Z direction. As a result, an internal space 150s separated into upper and lower portions is formed between the molds 151 and 152 except for a part thereof by the plurality of inserts 153.

In step S102, an acrylic resin is injected into the molds 151 and 152 to mold the light guide body 100. FIG. 5C illustrates a flow of the resin in the molds 151 and 152. The resin is injected to the lower portion of the internal space 150s through a through hole (not illustrated) of the mold 152, and fills the upper portion thereof through gaps between the plurality of inserts 153 while filling the lower portion in a direction of a black arrow. When the resin is cooled after a lapse of a certain time, the process proceeds to the next step.

In step S103, the mold 151 is pulled in the +Z direction to open the mold. As a result, as illustrated in FIG. 5D, the upper portion 101 is exposed on the mold 152 in a state where the lower portion 102 is fitted in the internal space of the mold 152.

In step S104, the plurality of inserts 153 are extracted. FIG. 5D illustrates a state in which the plurality of inserts 153 are extracted from the light guide body 100. The plurality of inserts 153 are extracted in a direction of an outlined arrow (+X direction). Note that the plurality of inserts 153 may be formed in a tapered shape in which a +X end portion is thinner than a -X end portion so as to be easily extracted from the light guide body 100.

In step S105, the light guide body 100 is removed from the mold 152. As a result, the light guide body 100 illustrated in FIG. 1A is obtained.

In step S106, the molds 151 and 152 and the plurality of inserts 153 are cleaned. Accordingly, the flow ends. By repeating steps S101 to S106, a plurality of light guide bodies 100 can be manufactured.

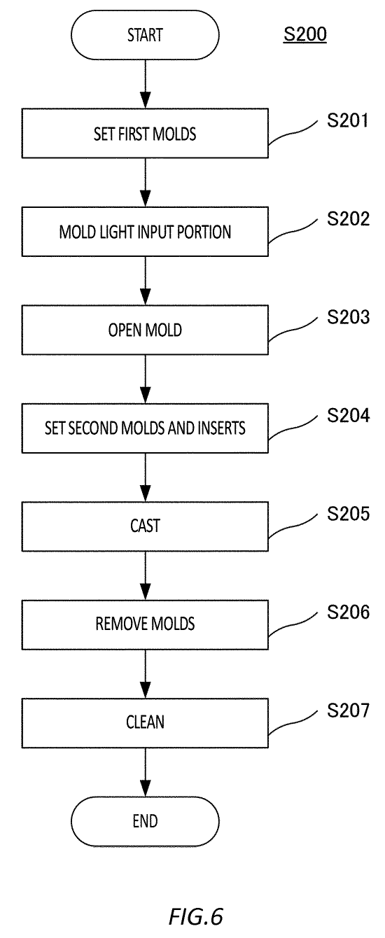

FIG. 6 illustrates a flow S200 of a second manufacturing method of the light guide body 100. In the present embodiment, as an example, an acrylic resin is used as a molding material of the light guide body 100. That is, the upper portion 101 and the lower portion 102 are formed of the same material.

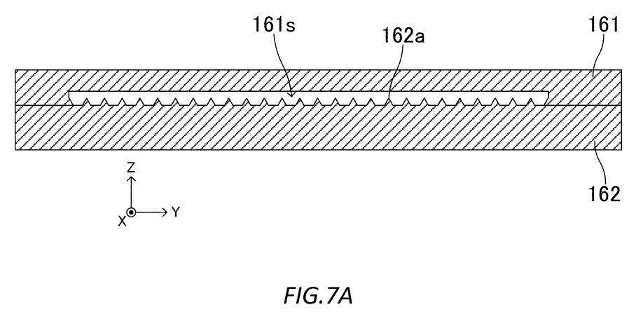

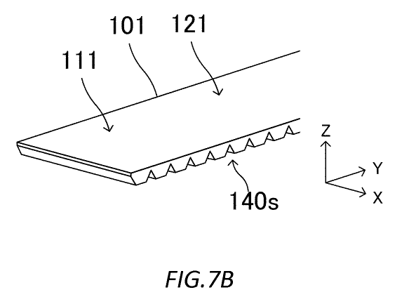

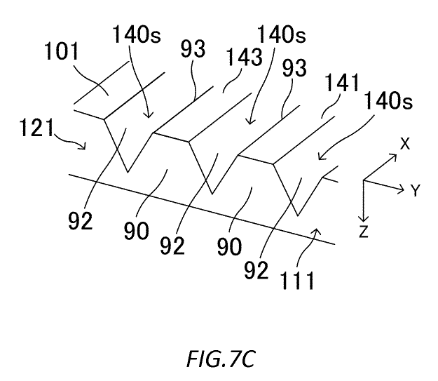

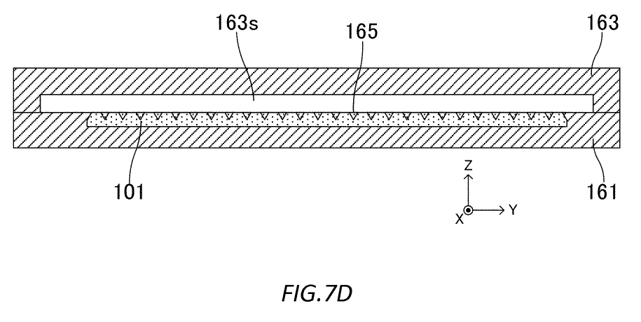

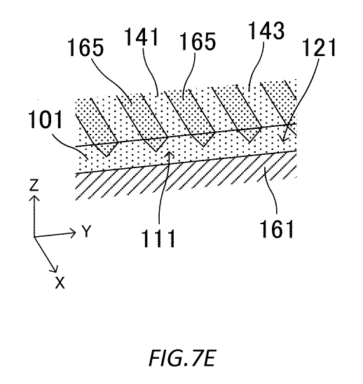

In step S201, molds 161 and 162 are set. FIG. 7A illustrates a state of the inside of the molds 161 and 162 in a front view (viewed in the X-axis direction). The molds 161 and 162 are a pair of metal molds for forming the upper portion 101. The mold 161 includes an internal space having a size and a shape capable of accommodating the upper portion 101. The mold 162 has a plurality of protrusion sides 162a protruding in the +Z direction from an upper surface thereof and arranged in the Y-axis direction. The plurality of protrusion sides 162a have a structure for forming the space 140s in the upper portion 101 (between the plurality of light collecting elements 90), and are formed to have a substantially isosceles triangular cross-sectional shape and extend in the X-axis direction.

The mold 162 is disposed with the plurality of protrusion sides 162a oriented in the +Z direction, and the mold 161 is placed on the mold 162 so as to accommodate the protrusion sides 162a with its internal space oriented in the -Z direction. As a result, an internal space 161s is formed between the molds 161 and 162.

In step S202, an acrylic resin is injected into the molds 161 and 162 to mold the upper portion 101. FIGS. 7B and 7C illustrate an overall configuration of the molded upper portion 101 and a structure thereof on the -Z side, respectively. As described above, the upper portion 101 is integrally molded such that the plurality of light collecting elements 90 are arranged in parallel in the Y-axis direction, and the space 140s is included between the light collecting elements 90 adjacent to each other. The continuous portions 141, 143, and 145 are formed on the -Z surfaces of the light collecting elements 90. That is, in the present example, the continuous portions 141, 143, and 145 are integrally molded with the upper portion 101. The detailed configurations of the continuous portions 141, 143, and 145 are as described above.

In step S203, the mold 162 is opened from the mold 161. In this state, the upper portion 101 is accommodated in the mold 161.

In step S204, molds 161 and 163 and a plurality of inserts 165 are set. FIGS. 7D and 7E illustrate a state of the inside of the molds 161 and 163 in a front view (viewed in the X-axis direction) and a perspective view, respectively. The mold 163 is configured similarly to the mold 152 described above. The plurality of inserts 165 are configured similarly to the inserts 153 described above. However, its length is equal to a width of the upper portion 101 in the X-axis direction.

The mold 161 in which the light input portion 110 is accommodated is turned upside down, the insert 165 is inserted into each of the plurality of spaces 140s of the upper portion 101, and the mold 163 is placed on the mold 161 with its internal space oriented in the -Z direction. As a result, the upper portion 101 in which the plurality of inserts 165 are respectively fitted into the spaces 140s is accommodated in the internal space of the mold 161, and an internal space 163s is formed between the mold 161 and the mold 163.

In step S205, an acrylic resin is injected into the molds 161 and 163 to mold the light guide body 100 by casting. The resin is injected into the internal space 163s through a through hole (not illustrated) of the mold 163, and fills the +Z side of the upper portion 101. When the resin is cooled after a lapse of a certain period of time, the resin forms the lower portion 102 and is integrated with the upper portion 101 via the continuous portions 141, 143, and 145 (see FIG. 7C).

In step S206, the light guide body 100 is removed from the molds 161 and 163, and the plurality of inserts 165 are removed from the light guide body 100. Note that the plurality of inserts 165 may be formed in a tapered shape in which a +X end portion is thinner than a -X end portion so as to be easily extracted from the light guide body 100. As a result, the light guide body 100 illustrated in FIG. 1A is obtained.

In step S207, the molds 161, 162, and 163 and the plurality of inserts 165 are cleaned. Accordingly, the flow ends. By repeating steps S201 to S207, a plurality of light guide bodies 100 can be manufactured.

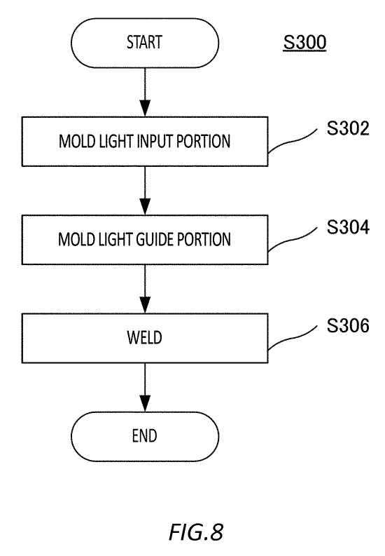

FIG. 8 illustrates a flow S300 of a third manufacturing method of the light guide body 100. In the present embodiment, as an example, an acrylic resin is used as a molding material of the light guide body 100. That is, the upper portion 101 and the lower portion 102 are formed of the same material.

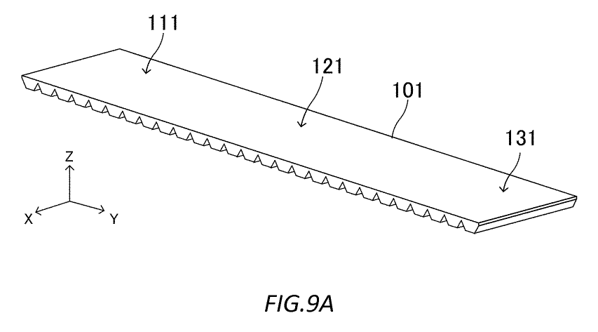

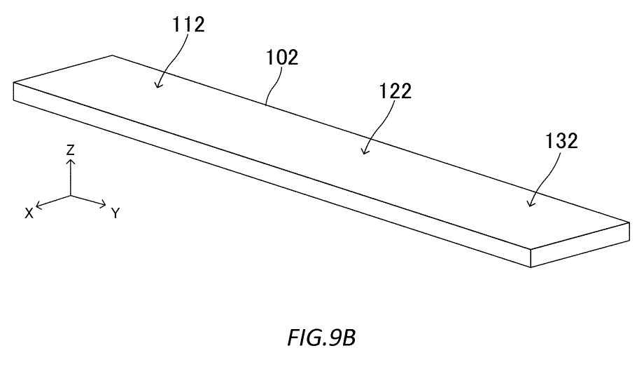

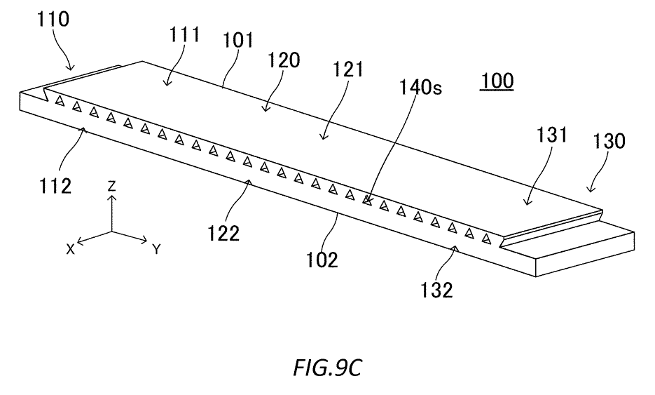

In step S302, the upper portion 101 is molded. The upper portion 101 can be molded by steps S201 to S203 described above. FIG. 9A illustrates a configuration of the molded upper portion 101. The upper portion 101 is formed separately from the lower portion 102.

In step S304, the lower portion 102 is molded. Details of molding are omitted. FIG. 9B illustrates a configuration of the molded lower portion 102. The lower portion 102 is formed separately from the upper portion 101.

In step S306, the upper portion 101 and the lower portion 102 are welded to form the light guide body 100. As illustrated in FIG. 9C, the upper portion 101 is disposed on the +Z end surface of the lower portion 102 with one end surface in which the space 140s is formed oriented toward the -Z side. Accordingly, the -Z surface of the upper portion 101 is brought into contact with the +Z end surface of the lower portion 102. In this state, ultrasonic vibration is applied to the upper portion 101 and/or the lower portion 102 to weld them. Thus, the upper portion 101 and the lower portion 102 are joined to each other via the continuous portions 141, 143, and 145 to form the light guide body 100.

Before application of ultrasonic vibration to the upper portion 101 and/or the lower portion 102, these welded portions may be irradiated with, for example, infrared rays to be preheated, the upper portion 101 and the lower portion 102 may be brought into contact with each other, and the upper portion 101 and the lower portion 102 may be welded by generating frictional heat by pressurizing them in a contact direction and vibrating them in a direction parallel to the contact surface. This makes it possible to perform welding with suppressed beads without air biting.

The present invention is not limited to the welding, for example, the upper portion 101 and the lower portion 102 may be bonded using a solvent. For example, a slight gap may be provided between the upper portion 101 and the lower portion 102, a photocurable adhesive may be poured into the gap by a capillary force, and the photocurable adhesive may be cured by irradiation with light to join the upper portion 101 and the lower portion 102. In addition, the upper portion 101 and the lower portion 102 may be joined using an optical tape (for example, ACO04N manufactured by 3M). The light guide body 100 may be molded using a 3D printer.

The light guide body 100 according to the present embodiment includes the light input portion 110 including the light input position 111a provided such that the light S is input in the Z-axis direction, the light guide portion 120 that guides the light input to the light input portion 110 in the Y-axis direction, and the light output portion 130 including the light output position 131a provided such that the light guided by the light guide portion 120 is output in the Z-axis direction, wherein the light guide portion 120 has the first light guide portion 121 and the second light guide portion 122 adjacent to each other in a direction intersecting (or orthogonal or substantially orthogonal to) the Y-axis direction, and the continuous portion 143 provided such that the first light guide portion 121 and the second light guide portion 122 are continuous and the discontinuous portion 144 provided such that the first light guide portion 121 and the second light guide portion 122 are separated from each other at the boundary between the first light guide portion 121 and the second light guide portion 122. According to this, the light S input to the light input portion 110 from the light input position 111a can be efficiently guided to the light output portion 130 via the light guide portion 120, and can be output from the light output positions 131a and 132a of the light output portion 130 different from the light input position 111a.

In addition, the mounted device 200 according to the present embodiment includes the light guide body 100 and the light emitting source 180 that emits light. According to this, the light emitted from the light emitting source 180 can be efficiently sent to the eye of the user via the light guide body 100.

Furthermore, the display device 210 according to the present embodiment includes the light guide body 100, the light emitting source 180 that emits light, and the display unit 190 on which the light output from the light guide body 100 is projected. According to this, the light emitted from the light emitting source 180 can be sent to the display unit 190 via the light guide body 100, and information such as a video or an image can be projected by the light.

Note that the space 140s in the light guide portion 120 may be a hollow space having a rectangular cross section in a front view that separates the entire first light guide portion 121 and the entire second light guide portion 122, instead of the hollow space having a triangular cross section in a front view. As a result, the entire +Z surface of the second light guide portion 122 functions as a reflecting surface.

Note that the upper surface (+Z surface) and the lower surface (-Z surface) of the light guide body 100 according to the present embodiment may be smooth surfaces. As a result, it is possible to prevent accumulation of dust or the like when the light guide body 100 is installed outdoors.

In the light guide body 100 according to the present embodiment, the light guide portion 120 is formed in a plate shape so as to extend in the Y-axis direction orthogonal to the light input direction (Z-axis direction). However, the present invention is not limited thereto, and the light guide portion may be formed to be curved in an arbitrary direction intersecting the input direction, for example, curved in an arc shape or a spherical shell shape. Furthermore, the light guide portion 120 may be formed so as to extend by being curved or bent in an arbitrary direction from a portion connected to the light input portion 110, or may be formed so as to extend to the light output portion 130 with a widening or decreasing width, or an increasing or decreasing thickness. As a result, the light collected by the light input portion 110 is guided into the light guide portion 120, and then guided in an arbitrary direction toward the light output portion 130 while being reflected by the end surface of the light guide portion 120.

Although the present invention has been described using the embodiments, the technical scope of the present invention is not limited to the scope described in the above embodiments. It will be apparent to those skilled in the art that various modifications or improvements may be made to the above embodiments. It will be apparent from the claims that such modified or improved forms may also be included within the technical scope of the present invention.

It should be noted that the order of execution of each processing such as operations, procedures, steps, and stages in the devices, systems, programs, and methods illustrated in the claims, the specification, and the drawings can be realized in any order unless “before”, “prior to”, or the like is specifically stated, and unless the output of the previous processing is used in the later processing. Even if the operation flow in the claims, the specification, and the drawings is described using “first”, “next”, or the like for convenience, it does not mean that it is essential to perform in this order.

### EXPLANATION OF REFERENCE NUMBERS

90: Light collecting element
92, 93: Reflecting surface
94: Light transmitting portion
100: Light guide body
101: Upper portion
102: Lower portion
110: Light input portion
111: First light input portion
111a: Light input position
112: Second light input portion
120: Light guide portion
121: First light guide portion
122: Second light guide portion
130: Light output portion
131: First light output portion
131a, 132a: Light output position
132: Second light output portion
140: Boundary portion
140s, 140sa, 140sb, 140s1 to 140s7: Internal space (space)
141, 143, 145: Continuous portion
142, 142a, 142b, 144, 146: Discontinuous portion
151, 152: Mold
153: Insert 161,
162, 163: Mold
161s: Internal space
162, 163: Mold
162a: Protrusion side
163s: Internal space
165: Insert
180: Light emitting source
181: Light source
182: Storage unit
183: Optical system
190: Display unit
191: Display surface
192: Optical system
200: Mounted device
210: Display device E: Eye S: Light.

What is claimed is:

1. A light guide body that outputs light, which is input from a light input position, from a light output position different from the light input position, the light guide body comprising:
a light input portion including the light input position provided such that the light is input in a first direction;
a light guide portion that guides the light, which is input to the light input portion, in a second direction intersecting the first direction; and
a light output portion including the light output position provided such that the light guided by the light guide portion is output in a third direction intersecting the second direction,
wherein the light guide portion has a first light guide portion and a second light guide portion adjacent to each other in a direction intersecting the second direction, and a continuous portion provided such that the first light guide portion and the second light guide portion are physically continuous and a discontinuous portion provided such that the first light guide portion and the second light guide portion are separated from each other at a boundary between the first light guide portion and the second light guide portion, and the first light guide portion and the second light guide portion are integrally stacked in the intersecting direction via the continuous portion.

2. The light guide body according to claim 1, wherein the light input portion has a first light input portion and a second light input portion that are adjacent in a direction intersecting the second direction, and another continuous portion provided such that the first light input portion and the second light input portion are physically continuous and another discontinuous portion provided such that the first light input portion and the second light input portion are separated from each other at a boundary between the first light input portion and the second light input portion.

3. The light guide body according to claim 2, wherein the light input portion has a reflecting surface provided to reflect the light, which is input in the first direction at the light input position, in the second direction, and the reflecting surface is formed at a boundary between the first light input portion and a hollow space formed in the light input portion.

4. The light guide body according to claim 1, wherein the light output portion has a first light output portion and a second light output portion that are adjacent in a direction intersecting the second direction, and further another continuous portion provided such that the first light output portion and the second light output portion are physically continuous and further another discontinuous portion provided such that the first light output portion and the second light output portion are separated from each other at a boundary between the first light output portion and the second light output portion.

5. The light guide body according to claim 2, wherein the light output portion has a first light output portion and a second light output portion that are adjacent in a direction intersecting the second direction, and further another continuous portion provided such that the first light output portion and the second light output portion are physically continuous and further another discontinuous portion provided such that the first light output portion and the second light output portion are separated from each other at a boundary between the first light output portion and the second light output portion.

6. The light guide body according to claim 3, wherein the light output portion has a first light output portion and a second light output portion that are adjacent in a direction intersecting the second direction, and further another continuous portion provided such that the first light output portion and the second light output portion are physically continuous and further another discontinuous portion provided such that the first light output portion and the second light output portion are separated from each other at a boundary between the first light output portion and the second light output portion.

7. The light guide body according to claim 4, wherein the light output portion has another reflecting surface provided to reflect the light, which is guided in the second direction by the light guide portion, in the third direction, and the another reflecting surface is formed at a boundary between the first light output portion and a hollow space formed in the light output portion.

8. The light guide body according to claim 1, wherein the light includes information.

9. The light guide body according to claim 2, wherein the light includes information.

10. The light guide body according to claim 3, wherein the light includes information.

11. The light guide body according to claim 8, wherein the information is recorded information.

12. The light guide body according to claim 8, wherein the information includes at least one of a video or an image.

13. The light guide body according to claim 8, wherein the light is light emitted from a light emitting source.

14. The light guide body according to claim 13, wherein the light emitting source has a storage unit that stores the information.

15. The light guide body according to claim 1, wherein the light guide body is installed on a mounted device that is mounted to a user.

16. The light guide body according to claim 1, wherein the light output portion outputs the light toward a display unit that displays information.

17. The light guide body according to claim 1, wherein an output direction of the light at the light output position is parallel to an input direction of the light at the light input position.

18. The light guide body according to claim 1, wherein an output direction of the light at the light output position is antiparallel to an input direction of the light at the light input position.

19. A mounted device that is mounted to a user, the mounted device comprising:
the light guide body according to claim 1; and
a light emitting source that emits the light.

20. A display device comprising:
the light guide body according to claim 1;
a light emitting source that emits the light; and
a display unit on which the light output from the light guide body is projected.
